(19) United States
(12) Patent Application Publication
(10) Pub. No.: US 2008/0001497 A1
(43) Pub. Date: Jan. 3, 2008

(54) DIRECT CONVERSION OF ALPHA/BETA NUCLEAR EMISSIONS INTO ELECTROMAGNETIC ENERGY

(75) Inventors: Alfred Y. WONG, Panorama City, CA (US); Glenn ROSENTHAL, Panorama City, CA (US)

Correspondence Address: NOVAK DRUCE DELUCA & QUIGG, LLP, 1300 EYE STREET NW, SUITE 1000 WEST TOWER, WASHINGTON, DC, 20005, US

(73) Assignee: NONLINEAR ION DYNAMICS, LLC, Panorama City, CA (US)

(21) Appl. No.: 11/734,919

(22) Filed: Apr. 13, 2007

Related U.S. Application Data
(63) Continuation-in-part of application No. PCT/US05/36822, filed on Oct. 14, 2005.
(60) Provisional application No. 60/522,567, filed on Oct. 14, 2004.
(60) Provisional application No. 60/702,284, filed on Jul. 26, 2005.
(60) Provisional application No. 60/744,813, filed on Apr. 13, 2006.

(51) Int. Cl. G21H 1/12

(52) U.S. Cl. 310/305

(57) ABSTRACT

An electromagnetic energy source is based on providing an alpha or beta emitting isotope contained in a medium, such as a high-pressure gas cell, or between layers of a semiconductor material such as silicon. The energy source may provide energy in the form of electric current, light, or other irradiative energy waveform, such as, for example, RF energy. Electrodes of different work functions in the cell provide an electromotive force that causes current flow.

### CLAIM OF PRIORITY UNDER 35 U.S.C. §119(e), 35 U.S.C. §365(c) and 35 U.S.C. §120

This application claims priority under 35 U.S.C. §119(e) from copending Provisional Application Ser. No. 60/744,813 filed Apr. 13, 2006; this application also claims priority under 35 U.S.C. §§365(c) and 120 from copending International Application No. PCT/US2005/036822 filed Oct. 14, 2005, which in turn claimed priority 35 U.S.C. §119(e) from Provisional Application Ser. No. 60/522,567 filed Oct. 14, 2004 and Provisional Application Ser. No. 60/702,284, filed Jul. 26, 2005.

### BACKGROUND OF THE INVENTION

1. Field of the Invention

This invention relates generally to radiant energy, and more particularly to conversion of emissions from a radioactive source into electromagnetic energy such as electric current, RF energy, or coherent light (laser) energy.

2. Summary of the Invention

The alpha-emitting nucleus is the most compact energy source available, with a potential power density greater than 10 watts/g and many years of operating lifetime. Alpha emitters with high specific energy and short stopping range facilitate the development of a miniature nuclear battery with power ranging from nanowatts to milliwatts or higher in a small cell volume of 1.0 cm³. A design using carefully selected chosen alpha emitting sources and cell wall materials has demonstrated that a safe, compact, long-lived nuclear battery is feasible using alpha emitters. Favorable scaling with small sizes and direct conversion of alpha energy into coherent radiation makes it possible to obtain efficiencies greater than that in thermal conversion. This high-pressure operation also allows beta decays to be used, thus giving rise to a large range of source materials and coherent radiation in the optical to x-ray range. Beta-emitting nuclei such as Ni63 can also be used in this concept, although beta emitters in general do not emit the same power densities. Additionally, a proton+Br-11 fusion reaction (which results in emission of 3 alphas) also could be used for the production of free electrons.

### BRIEF DESCRIPTION OF THE DRAWINGS

FIG. 1 is a diagram of an electric power source according to an embodiment of the invention;

FIG. 2 is a diagram showing structure of a nuclear battery according to an embodiment of the invention;

FIGS. 3a and 3b show a RIMS cell and RIMS cell array in accordance with another embodiment of the invention;

FIG. 4 is a diagram of an optical energy source according to yet another embodiment of the invention;

FIG. 5 is a graph of ion current as a function of gas pressure for an energy cell such as shown in FIGS. 3a and 3b;

FIG. 6 is a diagram illustrating one mode of operation of an electric power source according to the invention;

FIGS. 7a and 7b are diagrams illustrating possible device configurations of power sources in accordance with the invention;

FIG. 8 is a circuit diagram of an efficiency increasing resonant circuit coupled to a power source of the invention, according to yet another embodiment.

FIG. 9 is a cross-sectional diagram of a bi-metal silicon alpha battery cell according to another embodiment of the invention; and

FIG. 10 is a cross-sectional diagram showing an example embodiment of a bi-metal silicon alpha battery configured of a series connection of bi-metal silicon alpha battery cells as shown in FIG. 9, according to yet another embodiment of the invention.

### DETAILED DESCRIPTION OF PREFERRED EMBODIMENTS

A new electromagnetic energy source concept has been developed based on providing an alpha or beta emitting isotope contained in a high-pressure gas cell. The energy source may provide energy in the form of electric current, light, or other irradiative energy waveform, such as, for example, RF energy. Alpha emitters have the advantage of having very high specific energy (i.e., high energy per particle and per unit volume or mass). Furthermore alphas can be stopped within short distances in gases, thereby maintaining a high safety standard by preventing escape of alpha particles out of the cell. Our studies to date have resulted in reference designs of modular high pressure gas cells and special compositions that will allow the capture of the high energy content of alphas and betas from nuclear decays within micro-dimensions. The present invention, however, is not limited to such micro-dimensions, but contemplates scaling up to dimensions capable of producing power on the order of a conventional regional power plant, and further contemplates scaling down to dimensions supporting powering of nanotechnology applications. The concepts of the invention are described hereinafter with reference to a nuclear battery that directly converts alpha/beta emissions into electrical power for purposes of illustration and explanation only. The inventive concepts however are not limited to a nuclear battery, but as stated above extend to generation of a wide range of electromagnetic energy from the optical to the x-ray range.

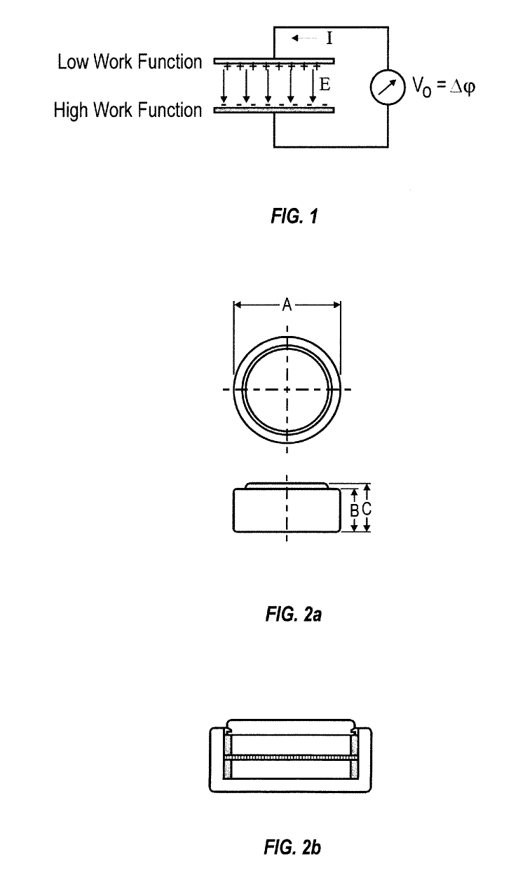

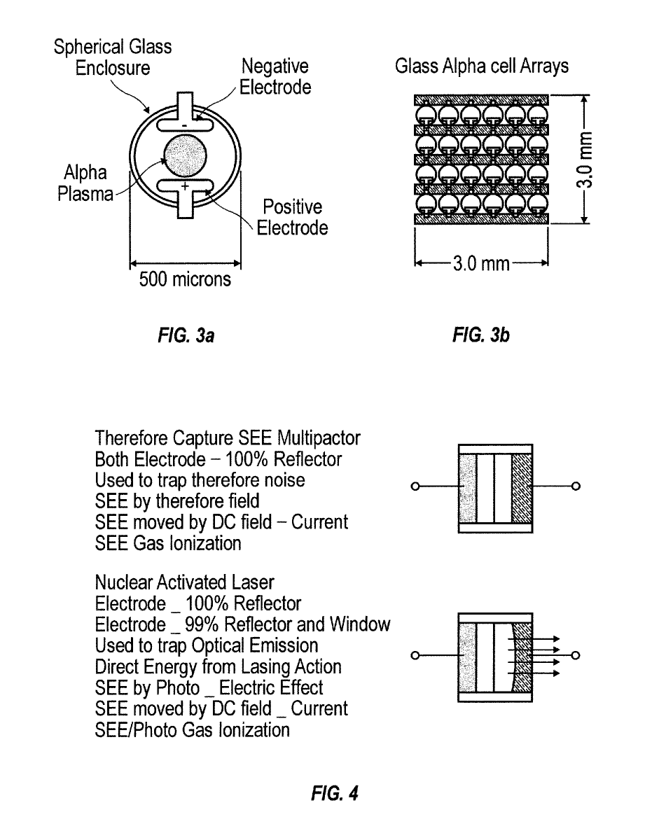

The basic operation of the battery uses two spaced apart dissimilar metal electrodes as shown in FIG. 1. The electrodes are placed within a hermetically sealed cell as shown in FIG. 3(a). A high-pressure gas is trapped within the cell and is ionized by the alpha emitter, which is suspended in the cell gas. The dissimilar metals have different work functions, with one of the electrodes having a relatively low work function, and the other electrode having a relatively high work function, thus generating an electromotive force (EMF) between the metals. With modern advances in materials science, it is now possible to generate voltage differences between 3.5-4.5 volts using carefully selected and prepared materials. Furthermore, a number of isotopes exist with sufficiently long half-lives to assure sustaining battery power for long periods of time, on the order of many years or more.

When an alpha particle travels through the high-density gas, it leaves a trail of ionized gas particles, creating a plasma. For example, a single 5 MeV alpha particle will create approximately 150,000 ion/electron pairs. These ions and electrons are accelerated by the EMF generated by the dissimilar metal work functions to generate an electrical current that can be driven through a load.

One basic concept of the design is that the alpha particles will primarily interact only with the gas in the cell. A careful selection of materials and high-pressure gas are chosen such that the alpha particles will have given up most (or all) of their energy before reaching the cell walls. This means that alpha damage to the cell walls is not a significant problem. The cell gases are chosen to maximize the energy conversion, but also to minimize the transmutation of the gas, as well as minimizing secondary radiation. This basic design allows the alpha-cell battery to operate reliably for extended periods of time, with minimal degradation and external radiation outside of the cell walls.

We have selected isotopes that can be produced readily using proven isotope separator and activator technologies. Example isotopes that can be used include Po-210, Po-208, Pu-238, U-235, Am-241 and Gd-148. By choosing an isotope with negligible gamma and neutron radiation, the alpha-cell battery is extremely safe. The combination of the cell gas and cell wall will stop and block all direct alpha radiation from escaping the cell. If the radioisotope is correctly chosen, there is negligible direct neutron, beta, and gamma radiation. The cell gas mixture is chosen such that none of the gases will emit significant secondary radiation, or transmutate, when bombarded with 5-6 MeV alpha particles, and thus secondary radiation also can be made negligible. Gases such as Kr, Xe, Ne, He, Ar, and many others are acceptable. Because alpha particles give up most (or all) of their energy before striking the cell wall, the choice of wall materials is less critical, and impurities in the wall will not emit significant radiation. For batteries with longer lives, it would be more practical to use isotopes with less specific activity but longer half-life than Po-210.

Burst mode for high density efficient energy storage can be provided via the use of a super-capacitor. During normal operation, energy is stored in a high efficiency super-capacitor. When a burst mode is required, the stored energy is discharged from the capacitor and used. The system is compact and efficient. The desired length of the burst mode will determine the exact size of the super-capacitor required.

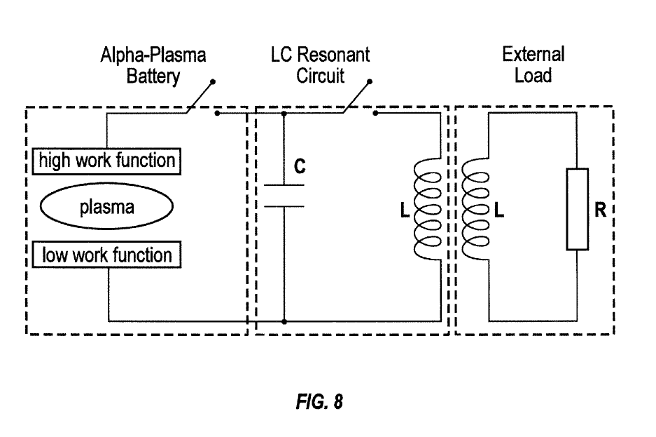

Combining this super-capacitor with an inductor and a switch as shown in FIG. 8, high voltages can be achieved. These high voltages from the order of volts to kilovolts can be used to extract electrical current from high density plasma sources. These high voltages will increase the current flow and thereby increase the power output and the efficiencies achieved. Experiments have found the current from an alpha battery continues to increase as the applied voltage to the battery is increased especially when the background pressure is high and the strength of the alpha emitter is high (above 1 mCi).

FIG. 8 shows the use of a resonant LC circuit to increase the efficiency of electron extraction from the plasma source. In particular, there exists an internal plasma charge resonance that is a function of plasma density. By coupling an external resonant circuit to the cell, such as the LC resonant LC circuit shown in FIG. 8, the natural resonance of the plasma source can be exploited by matching the internal resonant frequency of the plasma charge in the cell with the external resonant circuit, thereby increasing the amount of current extracted from the cell. In the circuit of FIG. 8, the switch connecting the plasma cell to the LC circuit would be closed during one half of the current cycle, such that charges build-up in the capacitor C in a single direction. Alternatively, current can be made to flow into the capacitor C during the entire cycle, by coupling a second switched plasma cell to the circuit, having opposite polarity from the plasma cell shown. In other words, the second plasma cell would have its low work function electrode and high work function electrode couple to the capacitor in the opposite manner than the plasma cell as shown in FIG. 8. Once current has begun to flow through the circuit, the resonance may make the current flow self-sustaining such that the need for switching may be eliminated.

This concept also is important when a high power unit is desired in the KW or MW range. The frequency of the power output is adjustable by the values of capacitor and inductor. For example, for high power supply applications the output is desirably in the range of 60 Hz. In an RFID application, output frequencies in the UHF range or microwave range would be desired.

We have discovered a favorable self-consistent scaling law, which shows that the current density increases with decreasing size and higher gas pressures. This allows a basic module to be created that can be integrated with a nano or micro circuit or arrayed together with additional modules to provide higher power, as shown in FIG. 3(b) for example. As an additional example, a simple battery design would have a battery shell within an 11.6 mm diameter×5.4 mm height button cell unit that has the same external dimensions as the commercial 357A button cell watch battery, as shown in FIG. 2. The device has a circular base area of 1.0 cm² and a volume of 0.5 cm³. The electromotive force of the battery is derived from contact voltage of electrodes with dissimilar work functions. The gas mixture used, the required gas pressure, and the plasma parameters can be selected using available data, computer code simulation, and experimental tests, which is within the skill level of those skilled in the art, and therefore will not be further discussed.

In addition to the miniature button cell design, modular micro-scale batteries for MEMS (Micro Electro-Mechanical Systems) applications can be produced in accordance with the invention. These alpha batteries can provide about 1.0 mW of electric power with an operational life of one year (these batteries generally require a radioisotope with high specific activity, such as Po-210). The output power of such a battery can be extended to the 10 mW range by constructing a parallel or serial array of this miniature module. The overall array dimension of the 10 button cell array can be 11.6 mm D (diameter)×54 mm H (height). The power levels and the physical dimensions are compatible with DARPA Advanced Technology Office (ATO) specified macro-scale systems. The device also could be used to trickle and recharge existing chemical batteries.

In general, smaller dimensions will result in higher electric field and more efficient current extraction from the plasma cell. As such, the alpha battery may work more efficiently in smaller sizes. For example, the dimension of the plasma cell can be reduced to 200-500 microns by compressing the gas mixture to about 100 atm. Thus a true micro-scale RIMS (Radioactive Isotope Micro-Supply) could be designed and built using the basic battery concept in accordance with the invention. An example of a spherical plasma cell enclosed by a glass sphere is shown in FIG. 3(a), where the electrodes are encapsulated with hermetic glass-to-metal seals. Arrays of the RIMS cells can be made in parallel to increase the current capability as needed, as shown in FIG. 3(b). Similarly, parallel arrays can be staged-up to generate the desired voltage according to demand.

A RIMS array also can be combined with a rechargeable micro battery or a super-capacitor as energy storage and a MEMS thermal converter for recapturing of thermal energy loss. This integrated alpha-based energy source will be capable of delivering from 1 to 10 mW of continuous power with 40 mW bursts for more than one year, in sizes less than 1 cm³.

In large-scale implementations, the DC electric field generated by electrodes with dissimilar functions may be reduced. New methods for producing electromotive force to boost up the battery efficiency have been proposed. A dynamic capacitor-charging EMF generator has been designed using switching capacitors together with dissimilar electrodes. With this technique the current extraction efficiency can be improved and optimized even in large-scale implementation systems where the spacing between electrodes becomes larger than a few centimeters. The efficiency of the nuclear battery can be enhanced by the larger internal DC electric field that results from the small gap spacing between the electrodes of different work functions.

The power conversion efficiency can be further improved by capturing optical and RF radiation from the plasma. Excess energy in the plasma is re-radiated to the surrounding surface in the form of light waves, which can be used as a laser source, and also high frequency microwaves. Interaction of such radiation with the material surface can generate cold secondary electrons if the surface material is selected to provide high SEE (Secondary Electron Emission) yields. This method is very attractive for adding electron current to the battery, thereby increasing the overall power conversion efficiency.

Microwave energy can be captured using microwave reflecting mirrors or electrodes, as shown in FIG. 4. Another method of capturing the excitation energy of alphas on the surrounding high-pressure gas is to select a mixture of gas such that metastable states can be excited. By making the electrodes serve as metallic mirrors to reflect optical radiation, a coherent light beam can be generated (also shown in FIG. 4). If one mirror has a lower reflectivity than the other mirror, then a coherent beam can emerge from the cell and be used either as a signal source or for direct energy conversion through an external semiconductor device.

Furthermore, the introduction of an AC drive using the ponderomotive force of very high frequency electromagnetic fields on electrons can augment the DC drive. Over an order of magnitude gain in efficiency over previous attempts at direct conversion to electric power conversion can be achieved. A ponderomotive force can be created by the preferential flow of laser or EM energy towards one direction. This direction is determined by the differential reflectivity of the two ends. As will be shown below, the laser energy is created by the pumping of energy levels within the gas cells by either alphas or betas which are emitted by nuclei. Alphas are the internal supplies of excited particles. With alphas, no external battery is needed because it becomes a self-generated power supply. Consequently, a completely self-contained laser source can be provided according to the invention.

A Large-Scale Isotope (LSI) battery can be combined with a rechargeable micro-battery or a super capacitor as an energy storage and thermal management unit for recapturing of thermal energy loss. The new integrated alpha-based energy source will be capable of delivering 10 mW of continuous power with 40 mW bursts for more than one year.

Design Requirements and Solutions

Matching the Cell Dimension to the Stopping Distance of the Alpha Particles

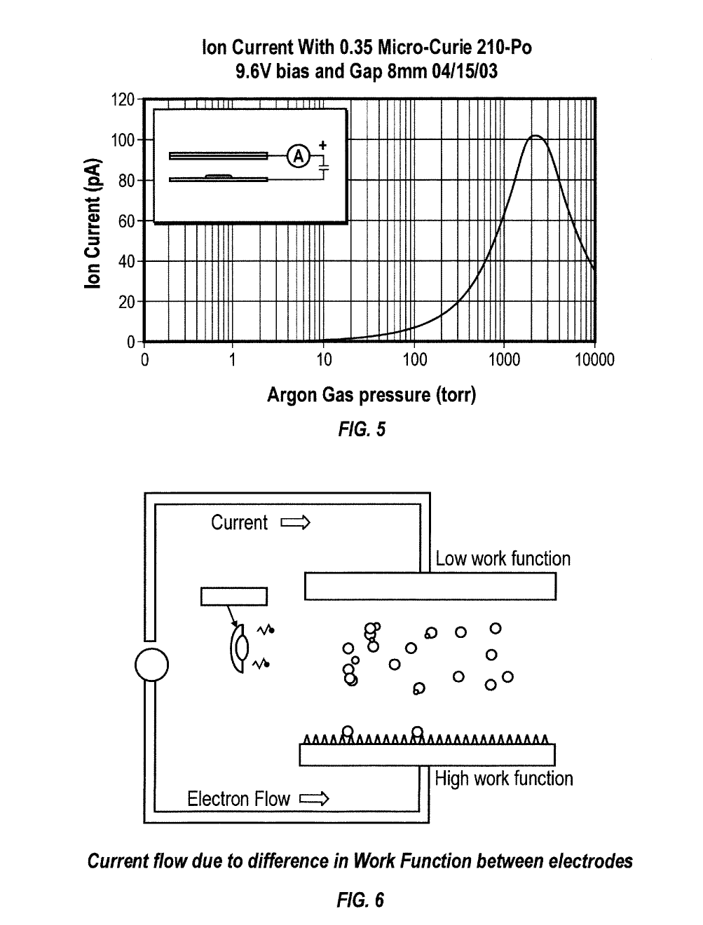

To fully utilize the alpha energy and minimize secondary radiation produced by energetic alpha particles and the cell wall, the gas pressure should be increased, such as by compressing the gas, so that the stopping range of the alpha particles in the compressed gas is about equal to the shortest cell dimension. For example, the stopping range is about 4 cm in air at one standard atmosphere pressure, p_{O}=1 atm. For a plasma cell dimension L smaller than 4 cm, the air pressure must be increased to roughly p=(4/L)p_{O}. The effect of matching the cell size to the stopping range is demonstrated in FIG. 5.

High Surface-to-Volume Isotope Suspender Grid Structure

Due to high-energy loss of alphas in the emitter material, the thickness of the emitter material in the battery must be kept very small. At 5 MeV, the energy loss of an alpha particle in a layer of Po is 207 keV per micron and the range is only 17.2 microns. Thus the material layer should be limited to one micron or less as a possible design requirement. This will keep the direct energy loss below 0.2 MeV. For a thin material layer far from other wall surfaces, the maximum utilization is about 50%, with the other 50% having been absorbed by the suspender material (i.e. Cu). In addition, the surface area available for coating the emitter material becomes a limiting parameter for the battery emitter material as well as for the battery power performance.

Derive Electromotive Force from Dissimilar Electrodes

In order to extract current from the plasma cell to the external load, an electromotive force (electric field) must be developed to move the negative charges such as electrons and negative ions to the negative electrode and the positive ions to the positive electrode. This electric field E will be provided by the differential work function Δφ of dissimilar electrodes, E=−Δφ/h.

In an alternative embodiment, as shown in FIG. 6, the surface of at least one of the electrodes is provided with “nanotips.” The nanotips provide multiple benefits. First, as the alpha or beta emissions occur in all directions, striking of the electrode surfaces by the alphas and/or betas will cause the electrode surfaces to be heated. The nanotips have the effect of increasing the surface area of the electrode. As such, the voltage potential between the electrodes may be increased by the thermoelectric (also known as Peltier) effect as the nanotip electrode will be heated to a higher temperature than the non-nanotip electrode. In this regard, isotope material may be applied directly to the nanotip surface, or preferably may be embedded within the nanotip structure itself. Preferably, the nanotips are located on the high work function electrode, as shown in FIG. 6; however the nanotips may be provided on the low function electrode with similar effect. By embedding the alpha or beta emitting isotope within a thin metal electrode, the thermionic emission may be sufficient to generate current without the need for plasma ionization.

Further, the geometry of the nanotips ensures that only the emission points at the ends of the nanotips are heated in a localized manner, with thermal insulation being provided between the tips and the main electrode plate. Such localized heating results in further electron ejection caused by thermionic emission.

Charge Separation and Plasma-Surface Interaction Processes

In order for maximum current to be fully extracted out to the electrodes to supply current to an external load, the charges in the gas cell must be rapidly moved to the electrodes. In order to maximize the current efficiency, it is necessary to select a gas mixture that will minimize recombination loss, maximize ion mobility and maximize secondary electron yield. A mixture of Xe and Ne or He, or Ar and Ne or He may give acceptable current extraction results. In these gas mixtures, the electron capture rates for forming negative ions are low, and hence the concentration of negative ions is also low. The additions of neon or helium gas in the gas mixture will increase the secondary electron yield as well as the ion mobility of the plasma. Increasing the secondary electron yield increases the electric current, because a secondary electron is functionally identical to a positive charge (ion), but has much higher mobility.

Scalability to Micro Electromechanical Systems Applications

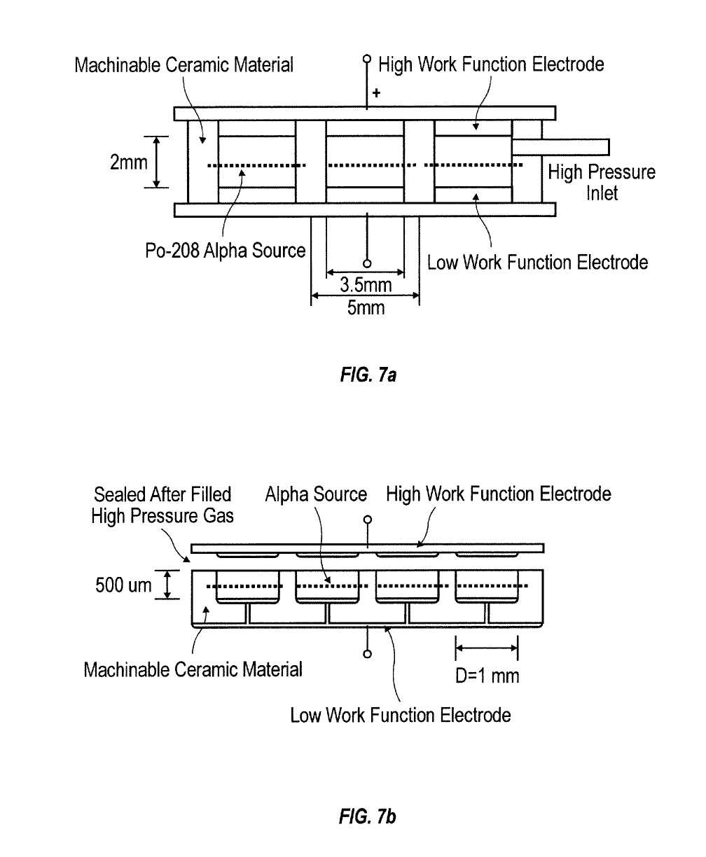

The dimensions of the alpha battery cell can be reduced to the 100-micron scale by using currently available high-pressure compression technology. Because the ion velocity is the product of ion mobility and the electric field, this quantity is approximately equal to a constant as the dimension L is reduced, while the gas pressure is increased proportional to 1/L. Thus the time required for moving the charge across the plasma cell can be shorter in smaller cells (the smaller the cell, the higher the current). As shown in FIGS. 7a and 7b, suitable cells can be manufactured from a machinable ceramic material to have very small dimensions.

Bi-Metal Silicon Battery Embodiment

In accordance with another embodiment of the invention, a new electromagnetic energy source concept has been developed based on providing an alpha or beta emitting isotope sandwiched between layers of an insulator material, such as silicon or germanium, which is capable of producing electron-hole pairs. The energy source may provide energy in the form of electric current, light, or other irradiative energy waveform, such as, for example, RF energy. Alpha emitters have the advantage of having very high specific energy (i.e., high energy per particle and per unit volume or mass). Furthermore alphas can be stopped within short distances in the silicon layer, thereby maintaining a high safety standard by preventing escape of alpha particles out of the battery cell. The concepts of the invention are described hereinafter with reference to a nuclear battery that directly converts alpha/beta emissions into electrical power for purposes of illustration and explanation only. The inventive concepts however are not limited to a nuclear battery, but as stated above extend to generation of a wide range of electromagnetic energy from the optical to the x-ray range.

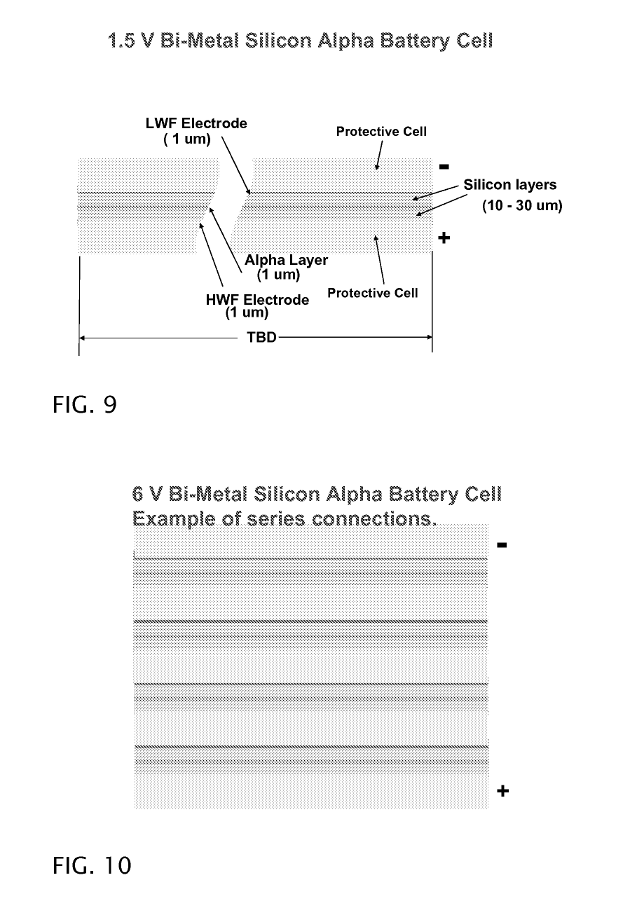

The basic operation of the battery according to one embodiment of the invention, as shown in FIG. 9, uses a layer of alpha/beta emitting isotope material embedded in a silicon layer or sandwiched between two silicon layers. Dissimilar metal electrodes of a low work function (LWF) and a high work function (HWF) are deposited or coated on the outer surfaces of respective silicon layers as shown in FIG. 9. The alpha-silicon-electrode structure is placed within a protective sealed cell material as shown. The dissimilar metals have different work functions, with one of the electrodes having a relatively low work function, and the other electrode having a relatively high work function, thus generating an electromotive force (EMF) between the metals. Because of the very small dimensions of the cell, only very low voltages are required to extract a flow of electrons. Furthermore, a number of isotopes exist with sufficiently long half-lives to assure sustaining battery power for long periods of time, on the order of many years or more.

FIG. 10 shows an example of a 6V bi-metal silicon alpha battery composed of a series connection of 1.5 V silicon alpha battery cells as shown in FIG. 9.

When an alpha particle travels from the alpha-emitting isotope into the silicon layer, it creates electron-hole pairs or charges. For example, a single 5 MeV alpha particle may create thousands or more electron/hole pairs. These electrons and holes are accelerated by the EMF generated by the dissimilar metal work functions to generate an electrical current that can be driven through a load.

One basic concept of the design is that using metallic electrodes and silicon surrounding the alpha emitter, the entire battery can operate at room temperature and at any atmospheric pressures. Because the silicon wafer is thin the electric field inside the silicon wafer is on the order of kilovolts/cm, which will give a sufficient drift velocity for electrons and holes to migrate to the respective electrodes, once the electron-hole pairs are produced by alpha collisions in the silicon layers. This is an improvement to the embodiment using high gas pressures, where ions and electrons migrate to the electrodes at a much slower rate (˜500 times slower). The effective mass of a hole is only three times that of an electron and its drift velocity is comparable to that of an electron. Since the electric current is governed by the drift rate of the slower species the current is therefore expected to be correspondingly higher than the case of using high-pressure gas. The ionization potential is estimated to be of the order of a few electron volts, which is eight times less than what is required to ionize a gas molecule.

We have discovered that silicon can be used as a solid medium to produce electron-hole pairs. These pairs are transported in silicon at a rate much faster than electrons and ions in high-pressure gases. A hole is a particle entity like an ion, with an effective mass m*, much less than an ion. In fact m* is close to the electron mass m. Silicon also serves as an insulator between the two bounding electrodes. The charges are produced only when alphas enter the medium.

We have selected isotopes that can be produced readily using proven isotope separator and activator technologies. Example isotopes that can be used include Po-210, Po-208, Pu-238, U-235, Am-241 and Gd-148. By choosing an isotope with negligible gamma and neutron radiation, the alpha-cell battery is extremely safe. The stopping distance of an alpha particle inside a material such as silicon is estimated to be approximately 10-30 microns. Therefore, making the thickness of the silicon layer just greater than the distance needed to stop an alpha particle will ensure that there is no external radiation from the battery.

Germanium is an important alternate to silicon. Other elements or combination of alloys or metals also are possible sources of electron-hole pairs in accordance with the present invention. The general requirement is only that small ionization energy and sufficient mobility of the electron-hole pairs be obtainable.

The use of silicon fits naturally into the fabrication of most solid state devices. Using the concept of a distributed power source, each power source can be situated adjacent to a semiconductor device which is made on a silicon substrate. In fact, the power source and the silicon integrated circuit can be on the same wafer since the alpha particles can be stopped within a distance of approximately 30 microns.

While alphas with an energy in the range of 5 MeV would easily damage a PN junction, the electric field and voltage is provided by the metallic electrodes according to the invention. Therefore, there is no need for a junction voltage and electric field with the alpha/beta silicon battery according to the invention.

An alternate solution is to coat silicon onto a gold electrode or a Mg—Al electrode. This should also work well.

The electron-hole pair producing medium could be pure silicon (which functions as an insulator), but also could include doped silicon to further lower the ionization potential. Phosphor and Boron are commonly used for doping.

Implementation of High Current Burst Operation

Super-capacitors are energy storage devices with high capacity and a low effective series resistance (ESR). Ultra-low ESR, ultra-thin (less than 1 mm thick) flat super-capacitors are currently developed and commercialized. By using the super-capacitor in parallel with the alpha-based battery, high-current burst operation can be implemented.

Adaptation of MEMS Thermal Converter to RIMS Array

By adapting a MEMS thermal converter to the RIMS array, excess thermal energy can be converted into electric power, thereby keeping the MEMS host system cooled and achieving unprecedented conversion efficiency. We expect to manufacture a device smaller than 1 cm³ that can deliver 10 mW continuously and last for years.

### CONCLUSION

With an innovative design using alpha emitters and a high-pressure gas cell, it is possible to make a highly reliable battery that is both safe and compact. The alpha emitter is chosen such that it has minimal gamma emission and no neutron emission. Since the alpha interacts primarily with the carefully chosen background gas, secondary radiation and damage to the battery structure are both negligible. Burst mode operation is provided by storing energy in a super-capacitor, which provides extremely efficient and compact energy storage. The size of the super-capacitor can be chosen to provide the length of burst required. Waste heat is recycled via thermal management to increase the overall efficiency and prevent heat build-up.

Additionally, with an innovative design using alpha emitters and a bi-metal silicon battery cell structure, it is possible to make a highly reliable battery that is both safe and compact. The alpha emitter is chosen such that it has minimal gamma emission and no neutron emission. Since the alpha interacts primarily with the silicon layer, secondary radiation and damage to the battery structure are both negligible. In summary, a new scheme for micro- and nano-sized nuclear batteries has been provided, whose design favors smaller scaling and modular construction.

In summary, a new scheme for micro- and nano-sized nuclear batteries has been provided, whose design favors smaller scaling and modular construction.

For the convenience of fabrication and future manufacturing, we have come up with a cylindrical geometry for our basic module. Our scaling law shows that the gas pressure, the charge density, the internal electric field drive, the current density and the specific power all increase as 1/h where h is the height of the cell size.

A grid of very fine wires or electroplating will aid in fabrication of extremely thin alpha/beta emitter-suspenders to avoid self-absorption. A shorter range of alphas leads to a smaller spacing between electrodes, which in turn leads to a favorable internal electric field inside the battery.

Alpha emitters such as Po-210, Po-208 and Gd-148 are preferred, although the invention contemplates the use of all alpha and beta emitters, as well as combinations of alpha and beta emitters, and additionally contemplates the use of fusion reactions such as proton+boron (11) (p+Br-11). The high-pressure background gas renders most source materials safe and efficient. The alpha emitters produce negligible neutron and gamma emission in primary emission and secondary interactions with surrounding gas and walls through appropriate choice of such materials.

The materials chosen for electrodes comply with neutron- and gamma-avoiding safety requirements, nuclear batteries containing these isotopes can be designed with combined neutron and gamma dose rate well below the generally accepted safety dosage. By using very fine Ag or Pt wires (˜10 microns) to support alpha emitters we can reduce absorption in the source region to below 50%. A high transparency is maintained in this suspender of fine wires such that electric current and very high frequency electromagnetic waves can pass through.

A complex gas mixture, containing non-monatomic gases such as CO₂, N₂, etc., in the cell can increase the efficiency of the cell by lowering the ionization energy of the gas and thus capturing more energy from the radioactive decay.

A complex gas mixture containing multiple types of gasses can be used to increase the cell efficiency since different gasses are better at capturing energy from alpha particles.

Enhancement of current generated in the alpha cell by allowing alpha particles to hit the positive electrode, which increases the negative current generated when secondary electrons are emitted from the positive electrode.

With proper mirrors surrounding the gas the coherent radiation can be obtained through multiple reflections between mirrors. The gain is high because the density of states per unit length is high. Conventional lasers cannot use such high-pressure gas because the excitation is by means of electrical discharges. Alphas and betas decaying from nuclei have naturally high energy and therefore can excite gases at very high pressures.

Alpha and beta sources generate a continuous current which can be used to charge a capacitor, thus building up a reservoir of charges. This capacitor can be used for burst mode operation to generate high pulse currents and high pulse powers.

This capacitor C in combination with an inductor L can be controlled to discharge in certain pulse codes with an electromagnetic frequency determined by L and C, thus giving rise to a unique pulse-code identification of the power source. In commercial applications an oscillating source is generally preferred.

This nuclear battery can be fabricated using nanotechnology or MEMS fabrication techniques. This approach allows the location of power supplies of various sizes in the immediate vicinity of any nano-circuit. Each circuit in the chip scale fabrication is therefore “indigenous” or “autonomous” in its design. Nuclear supplies are the smallest possible because a nucleus is five orders of magnitude smaller than an atom and its energy is derived from the conversion of mass into energy according to E=m C².

To recap, an electromagnetic energy source concept has been developed based on alpha emitters contained in a high-pressure gas cell, and alternately sandwiched between layers of a solid state material such as silicon or other appropriate semiconductor material. Alpha emitters have the advantage of having very high specific energy (high energy per emitted particle). Furthermore alphas can be stopped within short distances in gases, thereby maintaining a high safety standard. The basic operation of the battery uses two dissimilar metals joined by a hermetic seal. The dissimilar metals have different work functions, thus generating an electromotive force (EMF) between the metals. When an alpha particle travels through the high density gas, it leaves a trail of ionized particles, creating plasmas. These ions and electrons are accelerated by the EMF generated by the dissimilar metals to form a current that is driven through the load. These alphas also created excited states within a high-pressure gas, which results in very high amplification of optical signals of appropriate wavelengths. The basic concept of the design is that alpha particles primarily interact only with the high-pressure gas to produce a plasma which is self-healing.

What is claimed is:

1. An electric power source, comprising:
a cell containing a gas at a positive pressure;
an alpha- or beta-emitter located in said cell;
a positive electrode having one end located in said cell and a second end external to said cell; and
a negative electrode having one end located in said cell and a second end external to said cell;
whereby electric current will flow through a load connected between said second ends of said positive and negative electrodes.

2. The electric power source of claim 1, wherein said positive electrode has a work function that is different from said negative electrode.

3. The electric power source of claim 1, wherein said gas is selected from the group consisting of Xe, Ne, He, Kr, and Ar.

4. The electric power source of claim 3, wherein said gas is a mixture of elements from said group.

5. The electric power source of claim 3, wherein said gas is a mixture of elements from said group with CO₂ and/or N₂.

6. The electric power source of claim 1, wherein said alpha- or beta-emitter is an alpha-emitter selected from the group consisting of Po-210, Po-208, Pu-238, and Gd-148.

7. The electric power source of claim 1, wherein said alpha- or beta-emitter is a beta-emitter comprising Ni-63.

8. An RF energy source, comprising:
a cell containing a gas at a positive pressure;
an alpha- or beta-emitter located in said cell;
a first RF reflecting electrode located at one end of said cell; and
a second RF reflecting electrode located at an opposite end of said cell;
whereby RF energy will flow between said first and second RF reflecting electrodes.

9. The RF energy source of claim 8, wherein said gas is selected from the group consisting of Xe, Ne, He, Kr, and Ar.

10. The RF energy source of claim 9, wherein said gas is a mixture of elements from said group.

11. The RF energy source of claim 9, wherein said gas is a mixture of elements from said group with CO₂ and/or N₂.

12. The RF energy source of claim 8, wherein said alpha- or beta-emitter is an alpha-emitter selected from the group consisting of Po-210, Po-208, Pu-238, and Gd-148.

13. The RF energy source of claim 8, wherein said alpha- or beta-emitter is a beta-emitter comprising Ni-63.

14. A laser source, comprising:
a cell containing a gas at a positive pressure;
an alpha- or beta-emitter located in said cell, which causes emission of optical energy within said cell;
a first optical wave reflecting electrode located at one end of said cell; and
a second optical wave reflecting electrode located at an opposite end of said cell, said second optical wave reflecting electrode including a window that passes therethrough a coherent light wave of a predetermined magnitude;
whereby a coherent light beam produced from said emitted optical energy is reflected back and forth between said first and second optical wave reflecting electrodes and emanates from said second optical wave reflecting electrode once it has reached said predetermined magnitude.

15. The laser source of claim 14, wherein said gas is selected from the group consisting of Xe, Ne, He, Kr, and Ar.

16. The laser source of claim 15, wherein said gas is a mixture of elements from said group.

17. The laser source of claim 15, wherein said gas is a mixture of elements from said group with CO₂ and/or N₂.

18. The laser source of claim 14, wherein said alpha- or beta-emitter is an alpha-emitter selected from the group consisting of Po-210, Po-208, Pu-238, and Gd-148.

19. The laser source of claim 14, wherein said alpha- or beta-emitter is a beta-emitter comprising Ni-63.

20. An electric power source, comprising:
a cell containing a gas;
an alpha- or beta-emitter located in said cell;
a positive electrode having one end located in said cell and a second end external to said cell; and
a negative electrode having one end located in said cell and a second end external to said cell;
whereby electric current will flow through a load connected between said second ends of said positive and negative electrodes.

21. The electric power source of claim 20, wherein said alpha- or beta-emitter is embedded in one of said positive and negative electrodes.

22. The electric power source of claim 20, wherein one of said positive and negative electrodes is provided with a plurality of nanotip surfaces, and said alpha- or beta-emitter is applied as an isotope material to at least a portion of said nanotip surfaces.

23. The electric power source of claim 20, wherein said gas is compressed within said cell.

24. The electric power source of claim 20, wherein said alpha- or beta-emitter is suspended in said gas.

25. The electric power source of claim 20, wherein said alpha- or beta-emitter comprises a proton+boron-11 fusion reaction.

26. The electric power source of claim 20, further comprising a resonant circuit coupled to said positive and negative electrodes.

27. The electric power source of claim 26, wherein said resonant circuit comprises an LC circuit.

28. The electric power source of claim 26, further comprising a switch for controllably connecting said resonant circuit to said cell.

29. The electric power source of claim 20, wherein said electric power is in the form of RF energy.

30. A laser source, comprising:
a cell;
an alpha- or beta-emitter located in said cell, which causes generation of optical energy within said cell;
a first optical wave reflecting electrode located at one end of said cell; and
a second optical wave reflecting electrode located at an opposite end of said cell, said second optical wave reflecting electrode including a window that passes therethrough a coherent light wave of a predetermined magnitude;
whereby a coherent light beam produced from said emitted optical energy is reflected back and forth between said first and second optical wave reflecting electrodes and emanates from said second optical wave reflecting electrode once it has reached said predetermined magnitude.

31. An electric power source, comprising:
an alpha- or beta-emitter located in or sandwiched between layers of a solid medium capable of producing electron-hole charges;
a positive electrode contacting one end of said solid medium; and
a negative electrode contacting another end of said solid medium;
whereby electric current will flow through a load connected between said positive and negative electrodes.

32. The electric power source of claim 31, wherein said positive electrode has a work function that is different from said negative electrode.

33. The electric power source of claim 31, wherein said alpha- or beta emitter is an alpha-emitter selected from the group consisting of Po-210, Po-208, Pu-238, and Gd-148.

34. The electric power source of claim 31, wherein said alpha- or beta-emitter is a beta-emitter comprising Ni-63.

35. The electric power source of claim 31, wherein said solid medium comprises silicon.

36. The electric power source of claim 35, wherein said silicon medium is doped.

37. The electric power source of claim 31, wherein said solid medium comprises germanium.

38. The electric power source of claim 37, wherein said germanium medium is doped.

39. The electric power source of claim 31, wherein said solid medium comprises a metal.

40. The electric power source of claim 31, wherein said solid medium comprises an alloy.

41. An electric power source, comprising:
an alpha- or beta-emitter located in a medium capable of producing electron-hole charges;
a positive electrode contacting one end of said solid medium; and
a negative electrode contacting another end of said solid medium;
whereby electric current will flow through a load connected between said positive and negative electrodes.

42. The electric power source of claim 41, wherein said medium is a pair of semiconductor layers.

43. The electric power source of claim 41, wherein said medium is a cell containing a gas.
